(19) United States
(12) Patent Application Publication
(10) Pub. No.: US 2025/0034358 A1
(43) Pub. Date: Jan. 30, 2025

(54) LIQUID COBALT RESINATE COMPOSITIONS AND METHODS OF PREPARING THE SAME

(71) Applicant: UMICORE SPECIALTY MATERIALS BRUGGE, Brugge (BE)

(72) Inventors: Carl VERCAEMST, Brugge (BE); Rob DE VREESE, Brugge (BE); Jan DECAT, Brugge (BE)

(21) Appl. No.: 18/714,180

(22) PCT Filed: Dec. 5, 2022
(86) PCT No.: PCT/EP2022/084425

§ 371 Date: May 29, 2024

(30) Foreign Application Priority Data
Dec. 3, 2021 (EP) 21212234.5

(51) Int. Cl. C08K 5/13; C09D 7/63; C09D 193/04

(52) U.S. Cl. CPC C08K 5/13; C09D 7/63; C09D 193/04; C08K 2201/014

(57) ABSTRACT

The present invention provides liquid cobalt resinate compositions as a liquid composition for use in auto-oxidizable coatings or as accelerator in unsaturated polyester resins, comprising: i. cobalt resinate, in an amount of 0.5 to 6.0 wt. % cobalt, relative to the total weight of said liquid composition; ii. one or more antioxidants in an amount of 0.1 to 2.5 wt. %, relative to the total weight of said liquid composition; and iii. one or more organic solvents, in an amount of 25 to 90 wt. %, relative to the total weight of said liquid composition.

### TECHNICAL FIELD

The present invention relates to liquid compositions comprising cobalt resinate and methods for making the same. The invention especially relates to liquid cobalt resinate compositions suitable for use as drying agents for alkyd-based resins and unsaturated polyester resins.

### INTRODUCTION

Cobalt resinates have been used as driers in paints and varnishes up to the first half of the 20^{th} century. These resinates were prepared either by a precipitation method involving the exchange of alkali metals with cobalt in an alkali metal resinate, or by a fusion process involving the direct reaction of a cobalt compound with a rosin material. The precipitation method bears the disadvantage that it is a two-step process. The fusion method bears the disadvantage that generally no more than about 3 wt. % of cobalt can be incorporated in the rosin material. Higher amounts of cobalt indefinitely result in a phenomenon known as ‘blocking’ of the resinate. To this aim, U.S. Pat. No. 2,294,287 describes methods for preparing cobalt salts of partially hydrogenated rosin acids. The method essentially consists of heating the rosin material to a temperature of 240° C. to 330° C. under an inert atmosphere, and adding cobalt acetate and calcium acetate. As such, a clear, homogeneous solid cobalt resinate was obtained, having a cobalt content of 9% to 17%. U.S. Pat. No. 2,572,071 reports on methods for preparing metal resinates having an increased metal content, conchoidal fracture, and improved solubility in hydrocarbons, as well as having a better stability towards heat and air. The resinates are prepared by adding an aldehyde or an aldehyde forming agent to the composition. Although high metal content and good stability is achieved, metal aldehydes often are characterised by a strong colour, which makes them unsuitable for use in e.g. paints.

Difficulties in processability and the development of alternatives based on synthetic cobalt salts, which are easy to prepare and to process, made that industrial interest in metal resinates disappeared. Although resinate materials were largely disregarded since the advent of drier materials based on synthetic cobalt salts, renewed interest in this type of materials is triggered since rosin materials are environmentally safe, biobased and renewable. Yet, it remains that rosin materials are very difficult to process. Since these materials were out of scope for industrial uses, little is known on their processability.

Especially, new liquid compositions are required to allow the provision of e.g. a drier composition which comes up to the requirements and standards of current drier compositions, i.e. colour fastness, processability, stability, etc. Furthermore, new methods for preparation are desired to allow for a competitive and straightforward preparation and formulation of such compositions.

### SUMMARY OF THE INVENTION

The current invention provides a solution for at least one of the above mentioned problems by providing liquid cobalt resinate compositions, as described in claim 1, and methods of preparing the same.

It was found that the compositions according to the invention allow for ease of preparation, a sufficiently low viscosity, and furthermore show good stability, specifically good oxidative stability, good miscibility with alkyd resins and unsaturated polyester resins, and good characteristics as a drying agent.

### DETAILED DESCRIPTION OF THE INVENTION

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise,” “comprising,” and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

The recitation of numerical ranges by endpoints includes all numbers and fractions subsumed within that range, as well as the recited endpoints. All percentages are to be understood as percentage by weight, abbreviated as “wt. %” or as volume percent, abbreviated as “vol. %”, unless otherwise defined or unless a different meaning is obvious to the person skilled in the art from its use and in the context wherein it is used.

In a first aspect, the present invention provides a liquid composition, preferably a liquid siccative composition, for use in auto-oxidizable coatings or as accelerator in unsaturated polyester resins, comprising:
i. cobalt resinate, in an amount of 0.6 to 6 wt. % cobalt, relative to the total weight of said liquid composition; and
ii. an antioxidant in an amount of 0.05 to 2.5 wt. %, relative to the total weight of said liquid composition; and
iii. an organic solvent, in an amount of 25 to 90 wt. %, relative to the total weight of said liquid composition.

Said composition may further comprise residual amounts of water and/or additives such as a thinning agent. Preferably, the cobalt resinate, the antioxidant and the organic solvent are comprised in said liquid composition in a total amount of 90 to 100 wt. %, relative to the total weight of said composition, more preferably in an amount of more than 98 wt. % and more preferably more than 99 wt. %. Preferably, said liquid composition comprises water in an amount of less than 2 wt. %, preferably less than 1 wt. %, relative to the total weight of said composition.

Preferably, said organic solvent comprises one or more solvents of the group consisting of C8-C16 aliphatic hydrocarbons, C5-C10 aliphatic monoalcohol ethers, saturated and unsaturated C5-C30 esters, C5-C30 aliphatic monoalcohol esters, and C1-C6 N-alkylpyrrolidone. In the context of the present invention, the term “aliphatic compounds” comprises also “cycloaliphatic compounds.”

It was found that the compositions according to the invention allow for ease of preparation, a sufficiently low viscosity, and furthermore show good stability, specifically good oxidative stability, good miscibility with alkyd resins and unsaturated polyester resins, and good characteristics as a drying agent.

In the context of the present invention, the term “resinate” must be construed as the anionic base of rosin acid material, also referred to as a rosin material, including rosin material derivatives. The rosin material employed in our invention comprise gum rosin, wood rosin, pine oleoresin, material containing rosin or rosin acids such as pine gum, heat-treated rosin, stabilized rosin such as disproportionated rosin, hydrogenated and dehydrogenated rosin, partially hydrogenated and partially dehydrogenated rosin, and polymerized and partially polymerized rosin.

In the context of the present invention, the term “cobalt resinate” also comprises monomers, oligomers and/or polymers obtainable by reaction of said cobalt resinate with di- and/or polyalcohols and di- and/or polyacids. Furthermore, rosin materials suitable for use in the invention further comprise such materials as decarboxylated rosin, rosin oil, tail oil, esters of the rosin acids, such as methyl abietate, ester gum, vacuum strippings from rosin reactions, or any rosin-containing material which forms a cobalt salt can be obtained upon reaction of said rosin-containing material with a cobalt oxide, hydroxide, or a cobalt salt such as cobalt chloride, cobalt sulphate, etc. under the conditions of our process as described herein. Cobalt resinates may be prepared from any of these rosins, rosin-containing material, or rosin derivatives in accordance with our invention. In a specific embodiment, cobalt resinate may be defined by the general formula C40H58CoO4 and is synonymous to the term “cobalt(II+)(1R,4aR,4bR,10aR)-1,4a-dimethyl-7-(propan-2-yl)1,2,3,4,4a,4b,5,6,10,10a-decahydrophenanthrene-1-carboxylate.” The skilled person will understand that cobalt resinate may comprise other compounds, such as cobalt abietate, cobalt dehydroabietate, cobalt isopimarate, cobalt levopimarate, cobalt neoabietate, cobalt palustrate, cobalt pimarate, cobalt sandaracopimarate, colophony rosin gum, paraffin oil.

In an especially preferred embodiment of the present invention, the term “cobalt resinate” refers to monomeric, dimeric, trimeric and/or oligomeric cobalt resinate, and most preferably, the term “cobalt resinate” refers to monomeric and/or dimeric cobalt resinate. Oligomeric cobalt resinate is considered to have more than one and not more than 20 monomeric units, preferably more than one and not more than 10 monomeric units. Contrary to polymeric cobalt resinate, monomeric and oligomeric cobalt resinate provide the advantage that they allow for preparing solutions which are liquid in a relatively high concentration of cobalt, specifically up to 6 wt. % cobalt. The presence of monomeric and oligomeric cobalt resinate may be demonstrated by GPC analysis or NMR techniques.

In the context of the current invention, the term “liquid” refers to the state of the composition under standard conditions, i.e. standard temperature of 25° C. and standard pressure of 1 atmosphere.

Preferably, the present invention provides a liquid composition according to the first aspect of the invention, consisting essentially of said cobalt resinate and said organic solvent, further including also an antioxidant. Such compositions may further comprise residual amounts of water, stemming from e.g. the preparation of the liquid composition.

Preferably, the present invention provides a liquid composition according to the first aspect of the invention, wherein cobalt resinate is comprised in an amount of at least 0.5 wt. % of cobalt, relative to the total weight of said liquid composition, preferably at least 0.6 wt. %, more preferably at least 0.8 wt. %, at least 1.0 wt. %, at least 2.0 wt. %, at least 3.0 wt. %. Preferably, said cobalt resinate is comprised in an amount of at most 6.0 wt. % of cobalt, relative to the total weight of said liquid composition, more preferably at most 5.5 wt. %, or even at most 5.0 wt. %. Most preferably, cobalt resinate is comprised in an amount of cobalt of about 3.0 wt. %, 3.5 wt. %, 4.0 wt. %, 4.5 wt. %, or 5.0 wt. %.

Preferably, the present invention provides a liquid composition according to the first aspect of the invention, whereby said cobalt resinate is comprised in an amount of 90 wt. % to 25 wt. %, relative to the total weight of said liquid composition. More preferably, said cobalt resinate is comprised in an amount of 75 wt. % to 25 wt. %, and even more preferably in an amount of 60 wt. % to 40 wt. %. Most preferably, said cobalt resinate is comprised in an amount of about 50 wt. %. In a preferred embodiment, cobalt is comprised in said cobalt resinate in an amount of 6 to 10 wt. %, relative to the total weight of said cobalt resinate, preferably in an amount of 7 to 9 wt. %, and most preferably in an amount of about 8 wt. %.

Preferably, the present invention provides a liquid composition according to the first aspect of the invention, wherein said organic solvent is a hydrocarbon solvent comprising C9-C10 alkanes. Preferably, said hydrocarbon solvent is comprised in an amount of at least 30 wt. %, relative to the total weight of said organic solvent, more preferably in an amount of at least 40 wt. %, and most preferably in an amount of about 50 wt. %. Said hydrocarbon solvent may comprise n-alkanes, isoalkanes, and cycloalkanes. Said hydrocarbon solvent preferably has CAS No.: 64742-48-9 and preferably comprises less than 2% aromatics.

Preferably, the present invention provides a liquid composition according to the first aspect of the invention, wherein said organic solvent is a hydrocarbon solvent comprising C10-C13 alkanes. Preferably, said hydrocarbon solvent is comprised in an amount of at least 30 wt. %, relative to the total weight of said organic solvent, more preferably in an amount of at least 40 wt. %, and most preferably in an amount of about 50 wt. %. Said hydrocarbon solvent may comprise paraffins, isoparaffins, and cycloparaffins. Said hydrocarbon solvent preferably has CAS No.: 64742-48-9 and preferably comprises less than 2% aromatics.

In a preferred embodiment, the present invention provides a liquid composition according to the first aspect of the invention, wherein said organic solvent comprises a mixture of C9-C10 alkanes and C10-C13 alkanes.

Preferably, the present invention provides a liquid composition according to the first aspect of the invention, wherein said organic solvent comprises a C6-C10 aliphatic monoalcohol ether. Preferably, said C6-C10 aliphatic monoalcohol ether is comprised in an amount of at least 30 wt. %, relative to the total weight of said organic solvent, more preferably in an amount of at least 40 wt. %, and most preferably in an amount of about 50 wt. %. Preferably, said organic solvent comprises a C1-C6 alkyl ether of diethylene glycol or dipropylene glycol, and more preferably a C1-C4 alkyl ether of diethylene glycol or dipropylene glycol.

Preferably, the present invention provides a liquid composition according to the first aspect of the invention, wherein said organic solvent is a mixture of a hydrocarbon solvent comprising C10-C13 alkanes and a C6-C10 aliphatic monoalcohol ether, whereby said hydrocarbon solvent is comprised in an amount of 30 wt. % to 70 wt. %, relative to the total weight of said organic solvent, and whereby said aliphatic monoalcohol ether is comprised in an amount of 70 wt. % to 30 wt. %, relative to the total weight of said organic solvent, respectively. More preferably, said hydrocarbon solvent is comprised in an amount of 40 wt. % to 60 wt. %, and said aliphatic monoalcohol ether is comprised in an amount of 60 wt. % to 40 wt. %, respectively. Most preferably, said hydrocarbon solvent is comprised in an amount of about 50 wt. %, and said aliphatic monoalcohol ether is comprised in an amount of about 50 wt. %.

Preferably, the present invention provides a liquid composition according to the first aspect of the invention, wherein said organic solvent comprises one or more saturated and/or unsaturated C5-C11 esters. Preferred esters may be ethyl lactate.

Preferably, the present invention provides a liquid composition according to the first aspect of the invention, wherein said organic solvent comprises a mixture of saturated and unsaturated C12-C30 esters, more preferably of bio-based and/or biosourced saturated and unsaturated C12-C30 esters. Preferably, said unsaturated C12-C30 ester is comprised in an amount of at least 80 wt. %, relative to the total weight of the organic solvent, more preferably in an amount of at least 90 wt. %, and even more preferably in an amount of at least 98 wt. %. Preferably, said unsaturated C12-C30 ester is a methyl ester of rapeseed. Methyl ester of rapeseed (RME) is a methyl ester mixture made up of saturated and unsaturated C16 to C22 fatty acids. Technically, methyl esters of rapeseed are produced by chemical conversion of rapeseed oil using methanol.

Preferably, the present invention provides a liquid composition according to the first aspect of the invention, wherein said organic solvent comprises a C1-C6 N-alkyl pyrrolidone, more preferably a C4 N-alkyl pyrrolidone. Preferably, said C1-C6 N-alkyl pyrrolidone is comprised in an amount of at least 80 wt. %, relative to the total weight of the organic solvent, more preferably in an amount of at least 90 wt. %, and even more preferably in an amount of at least 98 wt. %. Preferably, said C1-C6 N-alkyl pyrrolidone is a C4 N-alkyl pyrrolidone.

Preferably, the present invention provides a liquid composition according to the first aspect of the invention, further comprising drying fatty acids, semi-drying fatty acids or mixtures thereof. Suitable drying fatty acids, semi-drying fatty acids or mixtures thereof, useful herein, are ethylenically unsaturated conjugated or non-conjugated C2-C24 carboxylic acids, such as oleic, ricinoleic, linoleic, linolenic, licanic acid and eleostearic acids or mixture thereof, typically used in the form of mixtures of fatty acids derived from natural or synthetic oils. By semi-drying and drying fatty acids is meant fatty acids that have the same fatty acid composition as the oils they are derived from.

The composition of the present invention is preferably stored under an inert atmosphere, for example nitrogen or carbon dioxide.

Preferably, the present invention provides a liquid composition according to the first aspect of the invention, wherein said cobalt resinate is prepared from a cobalt salt with a rosin or pine gum containing one or more resin acids, or stabilized rosin, such as disproportionated rosin, partially hydrogenated or partially dehydrogenated rosin. Preferably, the present invention provides a liquid composition according to the first aspect of the invention, wherein said cobalt resinate is a hydrogenated cobalt resinate. In general, as the metal content of a particular resinate is increased, the melting point is increased and the colour of the product is darkened. Typically, a cobalt salt of rosin or a rosin derivative in presence of an aldehyde such as paraldehyde, benzaldehyde, butyraldehyde or paraformaldehyde gives rise to a dark blue colour, even in presence of low amounts of aldehyde. The colour is darker with some aldehydes than with others. Such colour is disadvantageous when e.g. the cobalt resinate is to be used as a drying agent in a coating composition. Preferably, said liquid composition has a content of aldehydes or aldehyde forming products in an amount of less than 1.0 wt. %, relative to the total weight of said composition, more preferably in an amount of less than 0.5 wt. %, or even less than 0.1 wt. %. Most preferably, said liquid composition comprises no aldehydes or aldehyde forming products. Most preferably, said liquid composition is free of aldehydes or aldehyde forming products.

Preferably, the present invention provides a liquid composition according to the first aspect of the invention, said composition further comprising an antioxidant in an amount of 0.05 to 2.5 wt. %, relative to the total weight of said liquid composition, preferably in an amount of 0.4 to 1.5 wt. %, and more preferably in an amount of 0.50 wt. %, 0.60 wt. %, 0.80 wt. %, 1.00 wt. %, 1.20 wt. %, 1.40 wt. %, or 1.50 wt. %, or any amount there in between. Preferably, said antioxidant is a hydroxy alkylamine, a sterically hindered phenol, a phosphite, or a blend thereof. More preferably, said antioxidant is a sterically hindered phenol, a phosphite, or a blend thereof. Preferably, said antioxidant is a phenolic antioxidant such as butylated hydroxytoluene and cresylic acid, preferably a sterically hindered phenolic antioxidant; and/or a phosphite ester antioxidant such as trialkyl phosphite esters and alkyl-aryl phosphite esters. In an especially preferred embodiment, said antioxidant is butylated hydroxytoluene (BHT). In another preferred embodiment, said antioxidant is octadecyl 3-(3,5-ditert-butyl-4-hydroxyphenyl)propionate (ODP). Although liquid compositions according to the present invention were developed for use as a drying agent, the inclusion of antioxidants was surprisingly found not to impact the drying properties of the liquid composition.

Preferred sterically hindered phenols are selected from the list consisting of butylated hydroxy anisole (BHA); butylated hydroxy toluene (BHT); propyl gallate; 2,4,5-trihydroxybutyrophenone; dilaurylthiodipropionate; distearylthiodipropionate; gum guaiac; nordihydroguairetic acid; thiodipropionic acid; 2,2′-ethylidene-bis(4,6-di-tbutylphenol); 2-t-butylphenol; 2,6-di-t-butylphenol; 4-t-butyl-o-cresol; 6-t-butyl-ocresol; 2,6-dimethylphenol; 2,2′-methylenebis(4-methyl-6-t-butylphenol); 2,2′-methylenebis(2,6-di-t-butylphenol); catechol; t-butylcatecol; resorcinol; hydroquinone; 4,4′-thiobis(6-t-butyl-o-cresol).

Preferred phosphites have the general formula: (RO)(R¹O)(R²O)P or (R¹O)(R²O)P═O, wherein R2 and R1 are each selected from the group consisting of aryl, alkyl, cycloalkyl, arkaryl, aralkyl, alkoxy-aryl, alkoxy-alkyl, aryloxy alkyl and alkoxy cycloalkyl radicals containing at least 5 carbon atoms and mono OH substituted variants of foregoing, R is selected from the group consisting of hydrogen and R1 and R2 radicals. The neutral or tri-substituted phosphites are preferred.

Preferably, the present invention provides a liquid composition according to the first aspect of the invention, said liquid composition comprising an amount of water of not more than 1.00 wt %, relative to the total weight of the composition, preferably less than 0.25 wt. %, and more preferably comprising less than 0.10 wt. %.

The composition according to the first aspect of the invention is preferably stored under an inert atmosphere, for example nitrogen or carbon dioxide.

The cobalt resinate composition may be used in protective coatings, as catalytic drying agents for unsaturated vegetable oils, in fungicides, insecticides, bactericides, wood preservatives, surface undercoatings, mildew-roofing agents, rust-proofing agents, wetting and dispersing agents, lubricating agents, waterproofing agents, catalysts, glazing ceramics, etc.

In a second aspect, the present invention provides a process for preparing a liquid composition according to the first aspect of the invention, comprising the steps of:
i. dissolving a rosin material in an organic solvent at a temperature above 100° C., thereby obtaining a dissolved rosin material;
ii. adding a cobalt source to the dissolved rosin material and heating the obtained mixture to a temperature above 110° C., thereby obtaining a cobalt resinate in said organic solvent; and
iii. cooling to room temperature, thereby obtaining a liquid composition;
   whereby one or more antioxidants are added in an amount of 0.1 to 2.5 wt. %, relative to the total weight of said liquid composition. Said antioxidants may be added at any stage of the process, such as in step i., in step ii. or in step iii., prior to step i., in between step i. and step ii., in between step ii. and step iii., or post step iii.

Preferably, the present invention provides a process according to the second aspect of the invention, whereby said organic solvent comprises one or more of the group consisting of C8-C16 aliphatic hydrocarbons, C5-C10 aliphatic monoalcohol ethers, C5-C30 saturated and unsaturated esters, C5-C30 aliphatic monoalcohol esters, and C1-C6 N-alkylpyrrolidone.

Preferably, the present invention provides a process according to the second aspect of the invention, whereby in step i. said rosin material is added under rigorous stirring. Preferably, heating in step ii. is performed under vacuum and/or formed water from the reaction of a cobalt oxide or hydroxide with resin acid or volatiles formed by reaction of a cobaltous base with resin acid are distilled off.

Preferably, the present invention provides a process according to the second aspect of the invention, whereby said cobalt source is added to said dissolved rosin material in an amount of at least 0.50 and less than 1.00 equivalents, relative to two equivalents of carboxylic acid groups in said rosin. Preferably, said cobalt source is added in an amount of at least 0.60 and at most 0.95 equivalents, relative to two equivalents of carboxylic acid groups in said rosin, and more preferably in an amount of at least 0.70 and less than 0.90 equivalents, and most preferably, in an amount of about 0.72, 0.74, 0.76, 0.78, 0.80, 0.82, 0.84, 0.86 or 0.88 equivalents, or any value there in between.

Preferably, the present invention provides a process according to the second aspect of the invention, whereby said cobalt source is added at an average rate of at most 4 equivalents of cobalt per hour, relative to two equivalents of carboxylic acid groups in said rosin, more preferably at an average rate of at most 3 equivalents per hour, even more preferably at an average rate of at most 2 equivalents per hour of cobalt; and preferably at an average rate of at least 0.1 equivalents per hour, more preferably at least 0.2 equivalents per hour of cobalt, and even more preferably at least 0.5 equivalents per hour.

The cobalt source may be cobalt oxide, hydroxide, carbonate, basic carbonate, or may be a cobalt salt of organic or inorganic acids such as the formate, lactate, acetate, basic acetate. Preferably, the present invention provides a process according to the second aspect of the invention, whereby said cobalt source is cobalt hydroxide.

Preferably, the present invention provides a process according to the second aspect of the invention, whereby the formed cobalt resinate in said organic solvent, after cooling to a temperature below the reaction temperature, is filtered. Preferably, said cobalt resinate in said organic solvent is filtered through a 25 μm GAF bag filter.

Preferably, the present invention provides a process according to the second aspect of the invention, whereby an organic dimeric, trimeric or polymeric acid compound is added to said organic solvent comprising said dissolved rosin material after step i. and prior to step ii. Preferably, said dimeric acid compound is a dimeric fatty acid such as, but not limited to, dimerized oleic acid, and is preferably prepared by dimerizing unsaturated fatty acids obtained from tall oil. Said acid compound may further comprise a mixture of dimeric and trimeric acid compounds. Said organic dimeric, trimeric or polymeric acid compound are preferably identified by CAS number 61788-89-4.

Preferably, the present invention provides a process according to the second aspect of the invention, whereby a di- or polyalcohol is added to said cobalt resinate in said organic solvent after step ii. and prior to step iii. Preferably, said di- or polyalcohol is added in an equivalent amount relative to the amount of organic di- or polyacid compound added in step i. Preferably, said di- or polyalcohol is a C2-C8 alkyldiol such as—but not limited to—linear or branched, ethylene-, propylene-, butylene-, pentylene- and hexyleneglycol, or a C3-C8 alkyltriol such as—but not limited to—glycerol, and mixtures of one or more of the aforementioned.

Preferably, the present invention provides a process according to the second aspect of the invention, whereby said liquid composition is added to an alkyd-based resin or an unsaturated polyester resin in an amount of 0.1 to 2.5 wt. %, relative to the total weight of said curable liquid composition, preferably in an amount of 0.2 to 2.0 wt. %, more preferably in an amount of 0.5 to 1.5 wt. %, and even more preferably in an amount of 0.8 wt. %, 0.9 wt. %, 1.0 wt. %, 1.1 wt. %, 1.2 wt. %, or any amount there in between.

In a third aspect, the present invention provides a curable liquid composition comprising: a) an alkyd-based resin or an unsaturated polyester resin; and, b) 0.1 to 2.5 wt. %, relative to the total weight of said curable liquid composition, of a liquid composition according to the second aspect of the invention, preferably 0.2 to 2.0 wt. % of said liquid composition, more preferably 0.5 to 1.5 wt. %, and even more preferably 0.8 wt. %, 0.9 wt. %, 1.0 wt. %, 1.1 wt. %, 1.2 wt. %, or any amount there in between.

Suitable organic solvents to dilute the curable liquid compositions according to the third aspect of the invention, preferably air drying alkyd-based resins, include aliphatic, cycloaliphatic and aromatic hydrocarbons, alcohol ethers, alcohol esters and N-methylpyrrolidone. However, it may also be an aqueous carrier containing the alkyd resin in the form of an emulsion and a suitable emulsifier as is well known in the art.

The composition of the present invention may contain colourants, pigments, anticorrosive pigments, and/or extender pigments and/or a dyes. It may further contain, if necessary, plasticizer, surface-controlling agents, anti-fungal agents, biocides, anti-silking agent, anti-skinning agents, defoaming agents, rheological controlling agents and/or ultraviolet absorbers.

The addition of the liquid composition itself is done with conventional techniques, known to the person skilled in the art. The liquid is either added during the production of the alkyd based resins, coatings, inks, and linoleum floor coverings, or is added under stirring to them before use.

The composition according to the third aspect of the invention is preferably stored under an inert atmosphere, for example nitrogen or carbon dioxide.

In a fourth aspect, the present invention provides a use of a liquid composition according to the first aspect of the invention, as a drying agent in an alkyd-based resin or an unsaturated polyester resin.

### EXAMPLES

The following examples are intended to further clarify the present invention, and are nowhere intended to limit the scope of the present invention.

### Comparative Example 1

A cobalt polymer is prepared according to Example 2 of EP 3 095 826, and is designated as Comparative Example 1.

### Comparative Example 2

2 Equiv. (544.6 g) rosin were added to 700.0 g of a hydrocarbon solvent comprising C10-C13 alkanes and this mixture was heated to 140° C. Within one hour, all rosin solids dissolved and the mixture was stirred under nitrogen atmosphere. Next, 1 equiv. of cobalt hydroxide (80.0 g) was added in five portions over the course of 2 hours under continued stirring. After every addition water was distilled by vacuum distillation and temperature was increased by 10° C. to a final temperature of 180° C. During this procedure, viscosity started to rise and finally a non-usable solid product was obtained still containing unreacted cobalt hydroxide.

### Example 1

2.38 Equiv. (512.0 g) rosin were added to 350.0 g of a hydrocarbon solvent comprising C10-C13 alkanes and this mixture was heated to 125° C. Within one hour, all rosin solids dissolved and the mixture was stirred under nitrogen atmosphere. Next, 1 equiv. of cobalt hydroxide (56.9 g) was added in two portions over the course of 30 minutes and further reacted for an extra hour at 125° C. Then, water was distilled by vacuum distillation at 125° C. after which the product was cooled to 80° C. and filtered through a 25 μm GAF bag filter. To this homogeneous purple-blue mixture 0.2 wt. % of 2,6-di-tert-butyl-4-methylphenol (BHT) was added. Oxidative stability was achieved for at least two days before a greenish coloration was observed.

### Example 2

2.38 Equiv. (512.0 g) rosin were added to 350.0 g of a hydrocarbon solvent comprising C10-C13 alkanes and this mixture was heated to 125° C. Within one hour, all rosin solids dissolved and the mixture was stirred under nitrogen atmosphere. Next, 1 equiv. of cobalt hydroxide (56.9 g) was added in two portions over the course of 30 minutes and further reacted for an extra hour at 125° C. Then, water was distilled by vacuum distillation at 125° C. after which the product was cooled to 80° C. and filtered through a 25 μm GAF bag filter. To this homogeneous purple-blue mixture 1 wt. % of 2,6-di-tert-butyl-4-methylphenol (BHT) was added. This procedure resulted in a stable purple-blue Co-resinate solution containing 4% cobalt, 0.8% water and having a viscosity of 85 Poise. A GPC analysis (Agilent technologies 1260 infinity II GPC, RI detector, 2 subsequent Polypore columns, THF eluent, 30° C.) was done on this mixture revealing the absence of polymeric material, therefore yielding a product with acceptable viscosity for further industrial use as drier in alkyd paints and UPR.

### Example 3

184.2 g dimeric acid was heated to 130° C. for 30 minutes under nitrogen atmosphere. 866.9 g rosin was added gradually to said dimeric acid over a period of 30 minutes. Next, 80.0 g cobalt hydroxide was added in 5 equal portions to the prepared mixture over a period of 90 minutes at 140° C. Water formed during the reaction was distilled off under vacuum while a temperature of 140° C. was maintained. The mixture was subsequently heated to 160° C. and 46.0 g glycerine was added in portions over a period of 30 minutes. The polymerisation reaction was maintained for 1 hour at 180° C. after which all volatiles were distilled of at 180° C. and the product cooled to 140° C. Finally, 2.7 g BHT and 550.0 g of a 50/50 wt. % solution of a hydrocarbon solvent comprising C10-C13 alkanes and DPM were added to obtain a stable purple-blue Coresinate polymer solution containing 3% cobalt, 0.2% water and having a viscosity of 35 Poise.

### Example 4

600.0 g Co-resinate powder (8% Co) was dissolved at 50° C. in 600.0 g of a 50/50 wt. % solution of a hydrocarbon solvent comprising C10-C13 alkanes and DPM. To this solution 6 g of BHT was added and the mixture was stirred for an extra hour at 50° C. This resulted in a stable purple-blue Co-resinate solution containing 4% cobalt and having a viscosity of 1.7 Poise. A GPC analysis (Agilent technologies 1260 infinity II GPC, RI detector, 2 subsequent Polypore columns, THF eluent, 30° C.) was done on this mixture revealing the absence of polymeric material, therefore yielding a product with acceptable viscosity for further industrial use as drier in alkyd paints and UPR.

### Example 5

The product from Example 1 and 2 was made without antioxidant and tested with different kinds and concentrations of antioxidants on oxidative stability. To that end a 30 μm film of the product was applied on a glass plate in a controlled climate of 20° C. and 70% relative humidity and evaluated on oxidation stability. Results are summarized in Table 1.

TABLE 1
Oxidative stability of a 4% Co-resinate solution with
different antioxidants in function of number of days.

| | Days | | | | | | | | | |
|---|---|---|---|---|---|---|---|---|---|---|
| Wt. % | 1 | 2 | 3 | 4 | 5 | 8 | 9 | 10 | 13 | 14 |
| − ^{A} | − | − | − | − | − | − | − | − | − | − |
| 0.5 BHT | + | + | + | + | − | − | − | − | − | − |
| 1.0 BHT | + | + | + | + | + | + | + | + | + | − |
| 0.5 ODP | + | + | − | − | − | − | − | − | − | − |
| 1.0 ODP | + | + | − | − | − | − | − | − | − | − |

^{A} No antioxidant. Immediate oxidation was visibly observed by the discoloration of the liquid during filtration under air atmosphere.

### Example 6

The product obtained according to Example 2 or Comparative Example 1 were added to a white alkyd paint formulation in an amount of 0.05 wt. % Co on the solid alkyd resin. The used alkyd paint formulation is described in Table 2 and 3. The paint formulation was stored for 2 days at room temperature under an inert atmosphere, and was subsequently applied on a surface at a constant layer thickness of about 75 μm on glass plates and allowed to dry. An Elcometer® 5300 Ball Type Drying Time Recorder was used to determine the drying time of the white paints in a controlled climate of 20° C. and 70% relative humidity. The different drying states of the composition were determined according to method ASTM D5895-03. The results are depicted in Table 4.

TABLE 2
Base formulation

| | content/wt. % |
|---|---|
| Valires, long oil alkyd (70% solids) | 56.22% |
| D40 aliphatic solvent | 14.63% |
| Lecithine emulsifier | 0.41% |
| Bentone rheology modifier | 0.10% |
| White pigment | 28.63% |

TABLE 3
Formulation with driers and anti-skin agent

| | content/wt. % |
|---|---|
| Base formulation | 97.58% |
| Ca-neodecanoate solution (5% Ca) | 1.54% |
| D60 Zr-neodecanoate solution (18% Zr) | 0.21% |
| Example 2 or Comparative Example 1 (4% Co) | 0.47% |
| Anti-skinning agent | 0.20% |

TABLE 4
Drying times of Example 2 vs Comparative
Example 1 (hours:minutes)

| | Set-to- | Tack- | Dry- | Dry- |
|---|---|---|---|---|
| | Touch | Free | Hard | Through |
| Example 2 (4% Co) | 1:05 | 3:16 | 5:10 | 9:13 |
| Comparative | 1:01 | 2:56 | 4:50 | 9:46 |
| Example 1 (4% Co) | | | | |

### Example 7

0.25 g of Example 2 and Comparative Example 1 (both 4% Co), respectively, were homogeneously added to 100 g of a low reactive orthophthalic UPR resin. Then 1 g of peroxide curing agent was added and the mixture was vigorously stirred for 30 seconds, after which the gelling is monitored with a Brookfield Model DV-III Ultra Rheometer equipped with a SC4-27 spindle. Gel time (minutes), peak exotherm time (minutes) and peak exotherm temperature (° C.) were measured (Table 5).

TABLE 5
UPR activity low reactive UPR resin.

| | t_{gel} | Tₘₐₓ | t to Tₘₐₓ |
|---|---|---|---|
| | (min) | (° C.) | (min) |
| Example 2 (4% Co) | 8 | 105 | 23 |
| Comparative | 9 | 100 | 21 |
| Example 1 (4% Co) | | | |

### Example 8

The product from Example 4 was made without antioxidant and tested with different kinds and concentrations of antioxidants on oxidative stability. To that end a 30 μm film of the product was applied on a glass plate in a controlled climate of 20° C. and 70% relative humidity and evaluated on oxidation stability. Results are summarized in Table 6.

TABLE 6
Oxidative stability of a 4% Co-resinate solution with
different antioxidants in function of number of days.

| | Days | | | | | | | | |
|---|---|---|---|---|---|---|---|---|---|
| Wt. % | 1 | 2 | 5 | 7 | 8 | 9 | 12 | 13 | 14 |
| − ^{A} | − | − | − | − | − | − | − | − | − |
| 0.5 BHT | + | + | + | + | + | + | + | + | + |
| 1.0 BHT | + | + | + | + | + | + | + | + | + |
| 0.5 OTC | + | − | − | − | − | − | − | − | − |
| 1.0 OTC | + | − | − | − | − | − | − | − | − |
| 0.5 BPP | + | − | − | − | − | − | − | − | − |
| 1.0 BPP | + | + | − | − | − | − | − | − | − |
| 0.5 DEHA | + | + | + | + | + | + | + | + | + |
| 1.0 DEHA | + | + | + | + | + | + | + | + | + |
| 0.5 DOHA | + | + | − | − | − | − | − | − | − |
| 1.0 DOHA | + | + | − | − | − | − | − | − | − |
| 0.25 BHT/0.25 BPP | + | + | + | + | + | + | + | + | + |
| 0.50 BHT/0.50 BPP | + | + | + | + | + | + | + | + | + |
| 0.25 ODP/0.25 BPP | + | + | + | − | − | − | − | − | − |
| 0.50 ODP/0.50 BPP | + | + | + | + | + | − | − | − | − |
| 0.25 PET/0.25 BPP | + | + | − | − | − | − | − | − | − |
| 0.50 PET/0.50 BPP | + | + | − | − | − | − | − | − | − |

^{A} No antioxidant. Immediate oxidation was visibly observed by the discoloration of the liquid during filtration under air atmosphere.
OTC = 4,6-bis(octylthiomethyl)-o-cresol, BPP = tris(2,4-di-tert-butylphenyl)phosphite, DEHA = diethylhydroxylamine, DOHA = dioctadecylhydroxylamine, PET = Pentaerytritol-tetrakis-(3,5-di-tert-butyl-4-hydroxyhydrocinnamate).

### Example 9

70.0 g Co-resinate powder (8% Co) was dissolved at 50° C. in 70.0 g of rapeseed methyl ester. To this solution 0.7 g of BHT was added and the mixture was stirred for an extra hour at 50° C. This resulted in a stable purple-blue Co-resinate solution containing 4% cobalt and having a viscosity of 4.9 Poise.

### Example 10

The product from Example 9 was made without antioxidant and tested with different kinds and concentrations of antioxidants on oxidative stability. To that end a 30 μm film of the product was applied on a glass plate in a controlled climate of 20° C. and 70% relative humidity and evaluated on oxidation stability. Results are summarized in Table 7.

TABLE 7
Oxidative stability of a 4% Co-resinate solution with
different antioxidants in function of number of days.

| | Days | | | | |
|---|---|---|---|---|---|
| Wt. % | 1 | 2 | 5 | 6 | 7 |
| 0.5 BHT | + | + | − | − | − |
| 1.0 BHT | + | + | + | + | + |
| 0.5 DEHA | + | + | − | − | − |
| 1.0 DEHA | + | + | − | − | − |
| 0.25 BHT/0.25 BPP | + | + | − | − | − |
| 0.50 BHT/0.50 BPP | + | + | − | − | − |

DEHA = diethylhydroxylamine, BPP = tris(2,4-di-tert-butylphenyl)phosphite.

### Example 11

The product obtained according to Example 4 with different amounts of BHT (0.5, 1, 2, 4 or 8 wt. %) were added to an alkyd paint formulation in an amount of 0.05 wt. % Co on the solid alkyd resin. The used alkyd paint formulation is described in Table 8. The paint formulation was stored for 3 days at room temperature under an inert atmosphere, and was subsequently applied on a surface at a constant layer thickness of about 75 μm on glass plates and allowed to dry. An Elcometer® 5300 Ball Type Drying Time Recorder was used to determine the drying time of the white paints in a controlled climate of 20° C. and 70% relative humidity. The different drying states of the composition were determined according to method ASTM D5895-03. The results are depicted in Table 9. Adding an amount higher than 2 wt % BHT has a clear effect on drying times.

TABLE 8
Formulation with driers and anti-skin agent

| | content/wt. % |
|---|---|
| Valires, long oil alkyd (70% solids) | 97.45% |
| Ca-neodecanoate solution (5% Ca) | 1.36% |
| D60 Zr-neodecanoate solution (18% Zr) | 0.19% |
| Example 4 with 0.5, 1, 2, 4 or 8 wt. % BHT (4% Co) | 0.61% |
| Anti-skinning agent | 0.14% |

TABLE 9
Drying times of Example 4 0.5, 1,
2, 4 or 8 wt. % BHT (hours:minutes)

| | Set-to- | Tack- | Dry- | Dry- |
|---|---|---|---|---|
| | Touch | Free | Hard | Through |
| Example 4 (0.5 wt. % BHT) | 0:57 | 0:56 | 1:44 | 4:27 |
| Example 4 (1 wt. % BHT) | 0:56 | 1:00 | 1:22 | 4:10 |
| Example 4 (2 wt. % BHT) | 0:56 | 5:34 | 1:14 | 4:42 |
| Example 4 (4 wt. % BHT) | 1:02 | 13:53 | — | — |
| Example 4 (8 wt. % BHT) | 1:00 | — | — | — |

### Example 12

0.25 g of Example 4 (4% Co) with different amounts of BHT (0.5, 1, 2, 4 or 8 wt. %), were homogeneously added to 100 g of a low reactive orthophthalic UPR resin. Then 1 g of peroxide curing agent was added and the mixture was vigorously stirred for 30 seconds, after which the gelling is monitored with a Brookfield Model DV-III Ultra Rheometer equipped with a SC4-27 spindle. Gel time (minutes), peak exotherm time (minutes) and peak exotherm temperature (° C.) were measured (Table 10). Adding an amount higher than 2 wt. % BHT has a clear effect on UPR curing times.

TABLE 10
UPR activity low reactive UPR resin.

| | t_{gel} | Tₘₐₓ | t to Tₘₐₓ |
|---|---|---|---|
| | (min) | (° C.) | (min) |
| Example 4 (0.5 wt. % BHT) | 6 | 89 | 21 |
| Example 4 (1 wt. % BHT) | 5 | 88 | 21 |
| Example 4 (2 wt. % BHT) | 5 | 79 | 20 |
| Example 4 (4 wt. % BHT) | 8 | 78 | 31 |
| Example 4 (8 wt. % BHT) | 10 | 64 | 44 |

### Example 13

The product obtained according to Example 4 with different amounts of DEHA (diethylhydroxylamine, 0.5, 1, 2, 4 or 8 wt. %) were added to an alkyd paint formulation in an amount of 0.05 wt. % Co on the solid alkyd resin. The used alkyd paint formulation is described in Table 11. The paint formulation was stored for 3 days at room temperature under an inert atmosphere, and was subsequently applied on a surface at a constant layer thickness of about 75 μm on glass plates and allowed to dry. An Elcometer® 5300 Ball Type Drying Time Recorder was used to determine the drying time of the white paints in a controlled climate of 20° C. and 70% relative humidity. The different drying states of the composition were determined according to method ASTM D5895-03. The results are depicted in Table 12. Adding an amount higher than 0.5 wt % DEHA has a clear effect on drying times.

TABLE 11
Formulation with driers and anti-skin agent

| | content/wt. % |
|---|---|
| Valires, long oil alkyd (70% solids) | 97.45% |
| Ca-neodecanoate solution (5% Ca) | 1.36% |
| D60 Zr-neodecanoate solution (18% Zr) | 0.19% |
| Example 4 with 0.5, 1, 2, 4 or 8 wt. % DEHA (4% Co) | 0.61% |
| Anti-skinning agent | 0.14% |

TABLE 12
Drying times of Example 4 0.5, 1, 2,
4 or 8 wt. % DEHA (hours:minutes)

| | Set-to- | Tack- | Dry- | Dry- |
|---|---|---|---|---|
| | Touch | Free | Hard | Through |
| Example 4 (0.5 wt. % DEHA) | 0:24 | 1:09 | 2:13 | 7:47 |
| Example 4 (1 wt. % DEHA) | 0:26 | 4:51 | 1:55 | 12:06 |
| Example 4 (2 wt. % DEHA) | 0:30 | 6:40 | 1:16 | 13:04 |
| Example 4 (4 wt. % DEHA) | 0:28 | 7:04 | 1:00 | 12:40 |
| Example 4 (8 wt. % DEHA) | 0:28 | 8:55 | 0:59 | 15:24 |

### Example 14

0.25 g of Example 4 (4% Co) with different amounts of DEHA (diethylhydroxylamine, 0.5, 1, 2, 4 or 8 wt. %), were homogeneously added to 100 g of a second low reactive orthophthalic UPR resin. Then 1 g of peroxide curing agent was added and the mixture was vigorously stirred for 30 seconds, after which the gelling is monitored with a Brookfield Model DV-III Ultra Rheometer equipped with a SC4-27 spindle. Gel time (minutes), peak exotherm time (minutes) and peak exotherm temperature (° C.) were measured (Table 13). Adding an amount higher than 2 wt. % DEHA has a clear effect on UPR curing times.

TABLE 13
UPR activity low reactive UPR resin.

| | t_{gel} | Tₘₐₓ | t to Tₘₐₓ |
|---|---|---|---|
| | (min) | (° C.) | (min) |
| Example 4 (0.5 wt. % DEHA) | 15 | 149 | 28 |
| Example 4 (1 wt. % DEHA) | 14 | 147 | 26 |
| Example 4 (2 wt. % DEHA) | 18 | 155 | 29 |
| Example 4 (4 wt. % DEHA) | 24 | 147 | 39 |
| Example 4 (8 wt. % DEHA) | 49 | 142 | 67 |

### Comparative Example 3

83 g of polymerized rosin was heated to 160° C. and to this melted product were added 10 g of cobalt hydroxide in four portions of 2.5 g under nitrogen atmosphere. After 1 hour of reaction the mixture solidified and 66 g of a hydrocarbon solvent comprising C10-C13 alkanes and 1 g of BHT were added. This resulted in a liquid homogeneous mixture at 160° C. which solidified again after cooling to room temperature thus a nonusable solid product was obtained at room temperature.

1-17. (canceled)

18. A liquid composition for use in auto-oxidizable coatings or as accelerator in unsaturated polyester resins, comprising:
i. cobalt resinate, in an amount of 0.5 to 6.0 wt. % cobalt, relative to the total weight of said liquid composition;
ii. one or more antioxidants in an amount of 0.1 to 2.5 wt. %, relative to the total weight of said liquid composition; and
iii. one or more organic solvents, in an amount of 25 to 90 wt. %, relative to the total weight of said liquid composition.

19. The liquid composition according to claim 18, wherein said cobalt resinate comprises a monomeric, dimeric and/or trimeric cobalt resinate.

20. The liquid composition according to claim 18, wherein said antioxidant is selected from the group consisting of sterically hindered phenols and phosphites.

21. The liquid composition according to claim 18, wherein said one or more organic solvents comprise one or more solvents of the group consisting of C8-C16 aliphatic hydrocarbons, C5-C10 aliphatic monoalcohol ethers, saturated and unsaturated C5-C30 esters, C5-C30 aliphatic monoalcohol esters, and C1-C6 N-alkylpyrrolidone.

22. The liquid composition according to claim 18, comprising 1.0 to 6.0 wt. % cobalt, relative to the total weight of said liquid composition.

23. The liquid composition according to claim 18, said composition further comprising excess rosin material, in an amount of 0.1 to 1.0 equivalents relative to one equivalent of cobalt in said composition.

24. The liquid composition according to claim 18, wherein said antioxidant is butylated hydroxytoluene, and wherein said butylated hydroxytoluene is comprised in an amount of 0.5 to 2.5 wt. %, relative to the total weight of said liquid composition.

25. The liquid composition according to claim 18, wherein said organic solvent is comprised in an amount of 40 to 60 wt. %, relative to the total weight of said liquid composition, and wherein said cobalt resinate is comprised in an amount of 60 to 40 wt. %, relative to the total weight of said liquid composition, respectively.

26. The liquid composition according to claim 18, wherein said organic solvent is a hydrocarbon solvent comprising C10-C13 alkanes.

27. The liquid composition according to claim 18, wherein said organic solvent is a C6-C10 aliphatic monoalcohol ether.

28. The liquid composition according to claim 18, wherein said organic solvent is a mixture of a hydrocarbon solvent comprising C10-C13 alkanes and a C6-C10 aliphatic monoalcohol ether.

29. The liquid composition according to claim 18, wherein said cobalt resinate is a hydrogenated cobalt resinate.

30. The liquid composition according to claim 18, wherein said liquid composition is free of aldehydes.

31. A process for preparing a liquid composition according to claim 18, comprising the steps of:
i. dissolving a rosin material in an organic solvent at a temperature above 100° C.;
ii. adding a cobalt source to the dissolved rosin material and heating the obtained mixture to a temperature above 110° C., thereby obtaining a cobalt resinate; and
iii. cooling to room temperature, thereby obtaining a liquid composition;
whereby one or more antioxidants are added in an amount of 0.1 to 2.5 wt. %, relative to the total weight of said liquid composition.

32. The process according to claim 31, whereby said organic solvent comprises one or more solvents of the group consisting of C8-C16 aliphatic hydrocarbons, C5-C10 aliphatic monoalcohol ethers, saturated and unsaturated C5-C30 esters, C5-C30 aliphatic monoalcohol esters, and C1-C6 N-alkylpyrrolidone.

33. The process according to claim 31, whereby an organic dimeric, trimeric or polymeric acid compound is added to said organic solvent comprising said dissolved rosin material after step i. and prior to step ii., and whereby a di-, tri- or polyalcohol is added to said cobalt resinate in said organic solvent after step ii. and prior to step iii.

34. A curable liquid composition comprising: a) an alkyd-based resin or an unsaturated polyester resin; and, b) 0.1 to 2.5 wt. %, relative to the total weight of said curable liquid composition, of a liquid composition according to claim 18.
